(19) United States
(12) Patent Application Publication
(10) Pub. No.: US 2007/0040150 A1
(43) Pub. Date: Feb. 22, 2007

(54) Polymer coagulant solution, its preparing method and coagulation method using the same

(76) Inventors: Asaoka Keiichiro, Atsugi (JP); Nerome Hidetake, Naha (JP)

Correspondence Address: BUHLER ASSOCIATES;BUHLER, KIRK A., 1101 CALIFORNIA AVE., SUITE 208, CORONA, CA, 92881, US

(21) Appl. No.: 11/408,690

(22) Filed: Apr. 24, 2006

(30) Foreign Application Priority Data
Aug. 18, 2005 (JP) 2005-219006

(51) Int. Cl. C02F 5/08

(52) U.S. Cl. 252/175

(57) ABSTRACT

PROBLEM TO BE SOLVED: To provide a polymer coagulant solution that is capable of efficiently coagulating a suspension positively or negatively charged with one time water treatment by making an anionic polymer coagulant, a cationic polymer coagulant and a nonionic polymer coagulant coexist in the polymer coagulant solution, to provide its preparing method and to provide a coagulation method using the polymer coagulant solution. SOLUTION: The polymer coagulant solution is obtained by dissolving the anionic polymer coagulant, the cationic polymer coagulant and the nonionic polymer coagulant in an electrolytic solution with from the saturated concentration to the coagulation critical concentration.

### CROSS REFERENCE TO RELATED APPLICATION

This application claims priority to Japan application number 2005-219006 filed on Aug. 18, 2005.

### FIELD OF THE INVENTION

The present Invention is related to the amphoteric high-molecular flocculent which contains anionic, cationic and nonionic high-molecular flocculent together, and a method to produce the flocculent.

### BACKGROUND OF THE INVENTION

In order to remove suspended solid from waste water, flocculent has been used for the water treatment by adding it into the water to flocculate and settle the suspended solid, and high-molecular flocculent, such as polyacrylamid or its co-polymer are well known.

These high-molecular flocculent are classified into anion-type (anionic), cation-type (cationic) and nonion-type (nonionic) according to the electrical charge when it is dissolved in water.

Because most of suspended solid in waste water is electrically charged in positive or negative state, the suspended solid is effectively removed by forming large flocculation with the proper high-molecular flocculent selected from anion-type, cation-type or nonion-type flocculent according to the electrical charge of suspended solid and the treating method is well known. As an example, refer to Prior Art 1 (Japanese) Patent Publication 2002-346572.

### BRIEF SUMMARY OF THE INVENTION

It is an object of the amphoteric high-molecular flocculation solution described in the present invention has an advantage to effectively flocculate the suspended solid in waste water with a single procedure of process. The suspended solid is positively or negatively electric-charged in a solution and the amphoteric high-molecular flocculent consists of anion-type, cation-type and nonion-type high-molecular flocculent, which are positively or negatively electric-charged or no-electric charged, are dissolved in an electrolytic solution with its saturated to critical-flocculation concentration, and also can prevent from the treated water being polluted with the residual high-molecular flocculent because the non-reacted positively charged high-molecular flocculent and the non-reacted negatively charged high-molecular flocculent flocculate together without remaining in the processed water.

It is another object of the amphoteric high-molecular flocculent solution for the solution to be environmentally safe because the electrolytic solution is brine which can-contains the anionic, cationic and nonionic high-molecular flocculent together and because the dissolved high-molecular flocculent do not remain in the processed water after treatment.

It is another object of the amphoteric high-molecular flocculent solution to have the advantage of having dissolving characteristic because the concentration of brine is between its saturated concentration and one fourth (¼) of its saturation concentration.

It is another object of the amphoteric high-molecular flocculent solution to have the of adding sodium hydroxide into the brine not only to increase the flocculation capability but also to dissolve various kinds of high-molecular flocculent at ambient temperature without heating of the brine.

It is another object of the amphoteric high-molecular flocculent solution to include a method of producing the amphoteric high-molecular flocculent solution described in this application consisting of the method of producing brine with its saturated to its critical-flocculation concentration and of the method of dissolving anionic, cationic and nonionic high-molecular flocculent which are positively or negatively electric-charged in the brine in which these high molecular flocculent can coexist. The amphoteric high-molecular flocculent solution has an advantage to effectively flocculate, with a single procedure of treatment, the suspended solid which is positively or negatively electric-charged in a solution and also to prevent water pollution because the non-reacted positively charged high-molecular flocculent and the non-reacted negatively charged high-molecular flocculent flocculate together without remaining in the processed water after filtration.

It is another object of producing the amphoteric high-molecular flocculent solution wherein the concentration of the aforementioned brine is from its saturation to one fourth (¼) of its saturation, has an advantage to increase the dissolving amount of anionic, cationic and nonionic high-molecular flocculent in the brine.

It is another object of producing the amphoteric high-molecular flocculent solution wherein the method of producing the brine is consists of producing the saturated brine and of the method of producing the diluted brine higher than its critical-flocculation concentration, this has an advantage to produce the brine with its saturation to critical-flocculation concentration by an easy way of just diluting the saturated brine to its critical-flocculation concentration or the higher concentration.

It is another object of producing the amphoteric high-molecular flocculent solution wherein the dilution method of brine is to dilute up to four (4) times in volume in order to produce the brine with its saturation or up to the one fourth of saturation concentration, this has an advantage to increase the dilution amount of anionic, cationic and nonionic high-molecular flocculent into the brine.

It is another object of producing the amphoteric high-molecular flocculent solution wherein the brine is added with sodium hydroxide that has the advantage to dissolve various kinds of high-molecular flocculent into the brine at ambient temperature and also to increase the flocculation capability of the amphoteric high-molecular flocculent solution.

It is another object of producing the amphoteric high-molecular flocculent solution wherein the brine is added with sulfuric acid before the dissolving method and the high-molecular flocculent is added with sodium hydroxide after the aforementioned dissolving method, that has an advantage to dissolve various kinds of high-molecular flocculent into the brine in a short time at ambient temperature by sulfuric acid and to increase the flocculation capability of the amphoteric high-molecular flocculent solution.

It is another object of producing the amphoteric high-molecular flocculent solution wherein the method to mix the high-molecular flocculent solution into suspended solid solution, has an advantage to treat waste water easily just by mixing the amphoteric high-molecular flocculent solution into the waste water, by which the flocculent solution is diluted by the waste water and then the flocculent catches the suspended solid which are oppositely electric-charged to the flocculent after the diluted the flocculent solution reaches to the critical-flocculation concentration or the below.

Various objects, features, aspects, and advantages of the present invention and method will become more apparent from the following detailed description of preferred embodiments of the invention, along with the accompanying drawings in which like numerals represent like components.

### BRIEF DESCRIPTION OF THE DRAWINGS

FIG. 1 Shows a relationship between rock salt concentration and electric conductivity.

FIG. 2 Shows a relationship between potassium chloride concentration and its electric conductivity.

### DETAILED DESCRIPTION

Three different-ionized high-molecular flocculent can not be used at a time because these anion-type, cation-type and nonion-type flocculent flock together if being mixed into the waste water and do not function as flocculent, therefore the process must be separated for each type of flocculent, besides pH adjustment of the waste water that may be required, which makes the treatment process very troublesome as is described below:

(Step 1) Add sodium hydroxide to the suspended solid solution in order to keep weak alkaline.

(Step 2) Add sulfuric acid bund (positive electric charge) in order to form small size flocks.

(Step 3) Add anionic high-molecular flocculent (negatively charged) in order to form the larger size flocks and to settle the flocks.

(Step 4) If the forming of flocks is not enough, then cationic high-molecular flocculent (positively charged) is added.

(Step 5) If the forming of flocks is still not enough, then nonionic high-molecular flocculent (no electric charged) is added.

(Step 6) The pH value is adjusted at the end of process.

There has been a concern of safety in cases where the added high-molecular flocculent do not react and remain in the processed water. The water may carry the residual high-molecular flocculent of which monomer (such as acrylamid) may remain that has some toxic characteristic.

Means to Provide the Solution

The present invention provides amphoteric high molecular flocculent solution which is made by anionic high-molecular flocculent, cationic high-molecular flocculent and nonionic high-molecular flocculent all of which are dissolved in one electrolytic solution of its saturated concentration to its critical-flocculation concentration.

In this contemplated embodiment the amphoteric high-molecular flocculent solution wherein the electrolytic solution is brine.

In another contemplated embodiment the amphoteric high-molecular flocculent solution is a concentration of brine from its saturation to one forth (¼) concentration of saturation.

In another contemplated embodiment the amphoteric high-molecular flocculent solution the brine contains sodium hydroxide.

In a contemplated method of producing the amphoteric high-molecular flocculent solution the method to produce the brine is with its saturated concentration to its critical-flocculation concentration and with the method of dissolving anionic high-molecular flocculent, cationic high-molecular flocculent and nonionic high molecular flocculent together into the brine.

In another contemplated method of producing the amphoteric high-molecular flocculent solution the concentration of brine is saturation to one forth of its saturation.

In another contemplated method of producing the amphoteric high-molecular flocculent solution the method is consists of producing saturated brine and diluting the saturated brine to or above its critical-flocculation concentration (critical concentration to flocculate).

In another contemplated method of producing the amphoteric high-molecular flocculent solution the dilution method of saturated brine is to dilute the brine up to four times in volume.

In another contemplated method of producing the amphoteric high-molecular flocculent solution the method includes adding sodium hydroxide to the brine.

In a contemplated method of producing the amphoteric high-molecular flocculent solution the method includes adding sulfuric acid to the brine before the dissolving method and adding sodium hydroxide to the amphoteric high-molecular flocculent solution after the dissolving method.

In another contemplated method of producing the amphoteric high-molecular flocculent solution the method of flocculation wherein the method is to add and mix the amphoteric high-molecular flocculent solution in either claim 1 through 4 to waste water for flocculation of suspended solid.

### A PREFERRED EMBODIMENT OF THE INVENTION

The amphoteric high-molecular flocculent solution in the present invention is made by the method of dissolving anionic, cationic and nonionic flocculent together in one electrolytic solution of which concentration is between of its saturation and its critical-flocculation concentration.

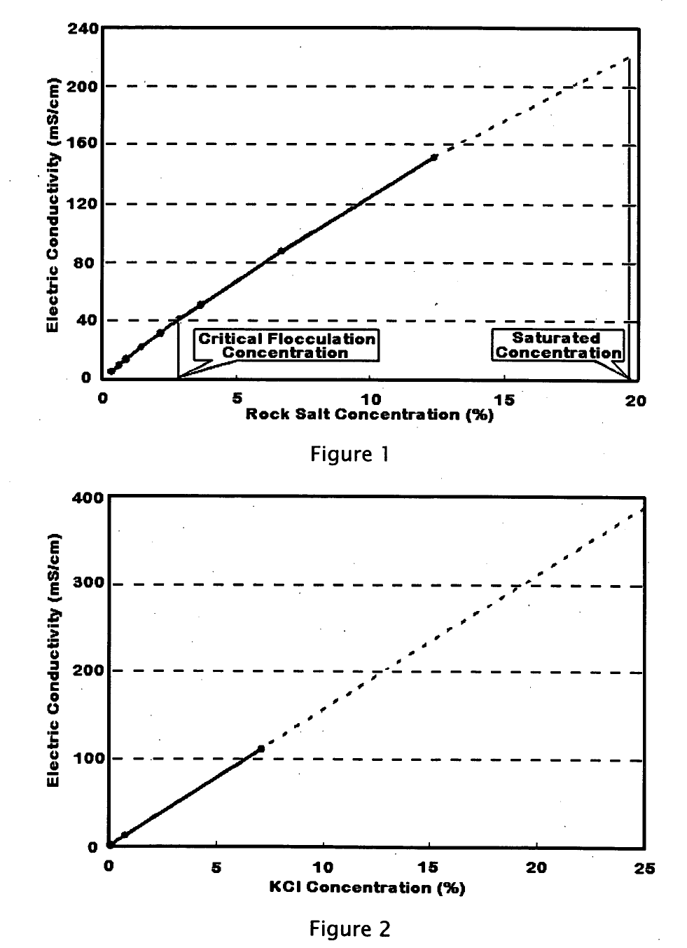

FIG. 1 shows the relationship between brine concentration at the temperature of 28 Deg. C. in which Chinese rock salt, mainly consisted of sodium chloride, is dissolved in water, and the electric conductivity of brine.

FIG. 2 shows the relationship between the concentration of KCI (potassium chloride) solution at 25 Deg. C. and the electric conductivity. (according to Rika-Nenpyou: Science Chronological Table)

As shown in FIG. 1 or FIG. 2, the electrolytic solution has a characteristic to increase its electric conductivity according to the increase of its concentration, and anion type, cation type and nonion type high molecular coagulant can coexist in the solution because the pulling force between the high-molecular flocculent, which are oppositely electric-charged, does not reveal out in the brine with its saturated concentration to its critical-flocculation concentration.

The amphoteric high-molecular flocculent can catch and flocculate the suspended solid which are electric-charged by the pulling force between the suspended solid and the high-molecular flocculent which are oppositely electric-charged against the suspended solid. In the process of dilution of the amphoteric high-molecular flocculent solution into the suspended solid solution of waste water and the electric conductivity, the brine is decreasing to the point where the concentration of the brine, in which the high-molecular flocculent is dissolved, becomes below its critical concentration for flocculation. The method of water treatment is environmentally safe because the non-reacted residual flocculent do not remain in the treated water after filtration of the flock of oppositely electric-charged high-molecular flocculent pulling each other.

The example of anion type high-molecular flocculent is, but not limited to, polymer of acrylic acid or its base, co-polymer with acrylamid and acrylic acid or its base, co-polymer with acrylamid and 2-acrylamid-2-methylpropane (isobutene) sulfonate base, tri-co-polymer with acrylamid, 2-acrylicamid-2-methylpropane (isobutene) sulponate base and acrylic acid or its base, partial hydrolysate of polyacrylamid.

An example of nonion type high-molecular flocculent includes, but is not limited to, polymer of arylamid

The cationic type high-molecular flocculent is the high-molecular flocculent which contains the functional base group in its chemical structure and the example of flocculent include, but are not limited to, polymer of III-charge or IV-charge base of dimethylaminoethyl (meta) acrylate (such as IV-charge base of methylchloride), co-polymer with acrylamid and III-charge or IV-charge Base of dimethylaminomethyl (meta) acrylate (such as IV-charge base of methylchloride), and high-molecular flocculent with N-vinylacrylamigine.

In a first preferred embodiment of the amphoteric high-molecular flocculent solution is described below.

The super saturated Brine is made with water and Chinese rock salt shown in FIG. 1 with the mixing ratio of 100 g of water to 30 g of Chinese rock salt, which are over the dissolving ratio at ambient temperature, and by agitating with submerged pump for enough dissolving. By skimming the solution as saturated brine, the one-fourth (¼) diluted brine is made by adding water 4 times in volume. The one-fourth (¼) diluted brine is also made directly by dissolving rock salt into water with the ratio of 7.5 g of rock salt and 100 g of water.

The diluted Brine is put into the high-molecular flocculent dissolving device which is composed of a bin to hold the brine, an electric heater to heat up the bin and an agitating propeller for the brine.

Each 1 kg of anion type high-molecular flocculent, cation type high-molecular flocculent and nonion type high-molecular flocculent is mixed into 1,000 kg of brine and then the heater is switched on to heat the brine to 70 Deg. C. with agitation by the propeller.

When the high-molecular flocculent are dissolved and the brine becomes transparent, the heater is switched off but the agitation is continues until the solution is cooled down to ambient temperature for completing production process of the amphoteric high-molecular flocculent solution.

Table 1 shows an example of Tufflock A-133 (anion type), C-806 (cation type) and N-131 (nonion type) produced by Taki-Chemical Industries, Co. Ltd were used as the high-molecular flocculent.

TABLE 1

| | Rock Salt | Electric Conductivity | Dissolving result of Amphoteric |
|---|---|---|---|
| | Concentration (%) | (mS/cm) | High Molecular Flocculent |
| Saturated Brine | 19.63 | 200 over | Completely dissolved in about 6 hrs |
| ×2 Dilution | 12.24 | 151.2 | at 70-80 Deg. C. |
| ×4 Dilution | 6.66 | 87.5 | |
| ×8 Dilution | 3.65 | 50.2 | Completely dissolved in about |
| ×10 Dilution | 2.85 | 41 | 10 hrs at 70-80 deg. C. |
| ×13 Dilution | 2.14 | 31.1 | Non viscous White Coloid |
| ×20 Dilution | 1.43 | 21.9 | Solution after 10 hrs agitation |
| ×33 Dilution | 0.86 | 13.6 | at 70-80 Deg. C. |
| ×50 Dilution | 0.58 | 9.5 | |
| ×100 Dilution | 0.31 | 5.1 | |

Table 1 shows the result of dissolving of three types of anion, cation and nonion high-molecular flocculent into the brine with the concentrations of rock salt in the preferred embodiment. The concentration of rock salt and the electric conductivity are the values at temperature of 28 Deg. C.

In Table 1, the diluted brine of less than 10 times volume dilution to the saturated brine (electric conductivity; 41.0 mS/cm) could dissolve the three types of high-molecular flocculent completely, however, the diluted brine of more than 13 times volume dilution (electric conductivity: 31.1 mS/cm) did not show the flocculation capability because the three types of high-molecular flocculent with opposite electric-charge flocked together in the brine.

The lowest concentration, at which the oppositely electric-charged high-molecular flocculent are completely dissolved, is defined critical-flocculation concentration. It is considered that the function of prohibiting the reaction of oppositely electric-charged ions each other by dissolving the high-molecular flocculent is related to the electric conductivity of Brine and that the concentration with its electric conductivity of approximate 40 mS/cm, based on the Table 1, is the critical-flocculation concentration.

In experiments it took 10 hours to dissolve the three types of high-molecular flocculent completely at the concentration with 8-10 times volume dilution, but it took 6 hours to dissolve the three types of high-molecular flocculent at the concentration with 1-4 times volume dilution.

It is considered that the concentration of brine is preferably more than one fourth (¼) of its saturated concentration.

In order to make reaction faster at water treatment and not to leave the brine in the treated water, it is preferable that the concentration of brine is close to the critical-flocculation concentration, which indicates that one fourth (¼) of the saturated concentration of brine is preferable, too.

The brine can be made not only by rock salt but also by the solution can include but not be limited to pure sodium chloride or potassium chloride as shown in FIG. 2.

In a second preferred embodiment a method to produce the amphoteric high-molecular flocculent solution is described below.

First, water is added for 10 times dilution to the saturated brine in this preferred embodiment 1 to produce the brine with one-tenth ( 1/10) saturated concentration.

2 cubic cm of 25% sodium hydroxide solution is added to the diluted brine to keep its pH about 11.

The diluted brine is then put into the amphoteric high-molecular flocculent dissolving device.

The amphoteric high-molecular flocculent solution is produced by adding anionic, cationic and nonionic flocculent to the brine with the ratio of each 1 g of Flocculent to 1 litter of brine. The solution is then agitating with a propeller at ambient temperature until the brine becomes transparent for about 10 hours in order to dissolve all added flocculent.

Comparing the two embodiments the time to dissolve the flocculent completely was almost same but the dissolving was achieved at ambient temperature without heating the brine, in addition, the flocculation capability was improved.

In a third preferred Embodiment of the method to produce the amphoteric high-molecular coagulant solution is described below.

First, water is added for 10 times volume dilution to the saturated Brine in the preferred embodiment 1 to produce the brine with one-tenth ( 1/10) saturated concentration.

2 cubic cm of 20% sulfuric acid solution is added to the diluted brine to keep pH between 1.0 and 1.6.

The diluted brine is put into the amphoteric high-molecular flocculent dissolving device.

The amphoteric high-molecular flocculent solution is produced by adding anionic, cationic and nonionic flocculent to the brine with the ratio of 1 g of flocculent to 1 litter of brine. The solution is then agitating with a propeller at ambient temperature until the brine becomes transparent for about 6 hours in order to dissolve all added flocculent. The pH is adjusted to approximately 10 by adding 2 cubic cm of 25% sodium hydroxide solution.

Similar results to preferred embodiment 2 were achieved where the Brine can dissolve the high-molecular flocculent at ambient temperature without heating the brine, and the time to complete dissolve was shortened. The flocculation capability was also improved.

Thus, specific embodiments of an amphoteric high-molecular flocculent solution and method have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A amphoteric high-molecular flocculent solution comprising:
an amphoteric high-molecular flocculent solution wherein anionic high-molecular flocculent, cationic high-molecular flocculent and nonionic high-molecular flocculent dissolved together in one electrolytic solution with its saturated concentration to its critical-flocculation concentration.

2. The amphoteric high-molecular flocculent solution from claim 1 wherein the electrolytic solution is brine.

3. The amphoteric high-molecular flocculent solution from claim 2 wherein the brine is with its saturated concentration to one fourth (¼) of its saturated concentration.

4. The amphoteric high-molecular flocculent solution from claim 2 or 3 wherein the aforementioned brine contains sodium chloride solution.

5. The amphoteric high-molecular flocculent solution from claim 1 that further includes method of mixing the amphoteric high-molecular flocculent solution into a suspended solid solution.

6. A method of producing amphoteric high-molecular flocculent solution comprising:
producing brine with its saturated concentration to its critical-flocculation concentration; and
dissolving anionic, cationic and nonionic high-molecular flocculent together in the brine.

7. The method of producing of amphoteric high-molecular flocculent solution in claim 6 wherein the method of producing the brine is with its saturated concentration to one fourth (¼) of its saturated concentration.

8. The method of producing amphoteric high-molecular flocculent solution in claim 6 wherein the method of producing the brine is with its saturated concentration and the method of dilution of the brine to its critical-flocculation concentration or higher concentration.

9. The method of producing amphoteric high-molecular flocculent solution in claim 8 wherein the method is consisted of the method of dilution of the aforementioned brine up to 4 times in volume or less.

10. The method of producing amphoteric high-molecular flocculent solution in claim 6 wherein the method is adding Sodium Hydroxide to the Brine.

11. A method of producing amphoteric high-molecular flocculent solution comprising:
producing brine with its saturated concentration to its critical-flocculation concentration;
adding sulfuric acid to the brine;
dissolving anionic, cationic and nonionic high-molecular flocculent together in the brine, and
adding sodium hydroxide to the amphoteric high-molecular flocculent solution.
